(19) United States
(12) Patent Application Publication
(10) Pub. No.: US 2010/0226472 A1
(43) Pub. Date: Sep. 9, 2010

(54) NUCLEAR FUEL ELEMENT AND ASSEMBLY

(75) Inventors: Howard A. Pendley, II, Chapin, SC (US); Max B. O'Cain, Lexington, SC (US); Yu C. Lee, Columbia, SC (US)

Correspondence Address: WESTINGHOUSE ELECTRIC COMPANY, LLC, P.O. BOX 355, PITTSBURGH, PA, 15230-0355, US

(73) Assignee: Westinghouse Electric Company LLC, Cranberry Township, PA (US)

(21) Appl. No.: 12/710,395

(22) Filed: Feb. 23, 2010

Related U.S. Application Data
(60) Provisional application No. 61/158,020, filed on Mar. 6, 2009.

(51) Int. Cl. G21C 3/06

(52) U.S. Cl. 376/416; 376/451

(57) ABSTRACT

A nuclear fuel element having a thick walled lower section that transitions to a thinner walled upper section with the transition forming an annular interior ledge that supports the fuel pellets spaced above a bottom end plug. The space between the fuel pellets and the bottom end plug forms a gas collection plenum that assures the necessary void volume exists to maintain margin to rod internal pressure limits.

### CROSS REFERENCE TO RELATED APPLICATION

This application claims priority to provisional Application Ser. No. 61/158,020, filed Mar. 6, 2009, entitled FUEL TUBE THICK WALL EXTENSION.

### BACKGROUND OF THE INVENTION

1. Field of the Invention

This present invention relates generally to nuclear reactor fuel assemblies, and more particularly, is concerned with an improved nuclear reactor fuel element.

2. Description of the Related Art

During manufacture, subsequent installation and repair of components of a nuclear coolant circulation system, diligent effort is made to help assure the removal of all debris from the reactor vessel and its associated systems, which circulate coolant throughout the primary reactor coolant loop under various operating conditions. Although elaborate procedures are carried out to help assure debris removal, experience shows that in spite of the safeguards used to effect such removal, some chips and metal particles still remain hidden in the system. Most of the debris is in the form of stainless steel metallic shavings, machine turnings, wire bristles, chips with Stellite hard surface coating and the like, which were probably left in the primary system after steam generator repair or replacement.

In particular, fuel assembly damage due to debris trapped at the lower most grid has been noted in several reactors in recent years. Debris enters through the fuel assembly bottom nozzle flow holes from the coolant flow openings in the lower core support plate when the plant is started up. The debris tends to be engaged in the lower most support grid of the fuel assembly within the spaces between the “egg-crate” shaped cell walls of the grid and the lower end portions of the fuel rod tubes (also referred to as cladding). The damage consists of fuel rod tube perforations caused by fretting of the debris in contact with the exterior of the cladding tubes which sealably enclose the fissile material. Debris also becomes entangled in the bottom nozzle top plate holes and the flowing coolant causes the debris to gyrate, which tends to cut through the cladding of the fuel rods.

Several different approaches have been proposed and tried for carrying out the removal of debris from nuclear reactors. Many of these approaches are discussed in U.S. Pat. No. 4,096,032 to Mayers et al. Others are illustrated and described in the various patents cross referenced in U.S. Pat. No. 4,900,507, and in U.S. patent application Ser. No. 12/480,827, filed Jun. 9, 2009 (ARF 2009-002), both of which are assigned to the Assignee of this invention. While all of the approaches described in the cited references and cross references operate reasonably well and generally achieve their objective under the range of operating conditions for which they were designed, a need still exists for a further improved approach to the problem of fuel rod fretting along the lower portion of the fuel element cladding.

### SUMMARY OF THE INVENTION

The present invention provides an improved nuclear fuel element having an elongated tubular cladding with an axial dimension. A lower end portion of the nuclear fuel element has a first wall section having a first thickness. The first thickness extends around a circumference of the cladding and along the axial dimension a first preselected distance. The elongated tubular cladding also has an upper portion, above the lower end portion, with a second wall section having a second thickness. The second thickness extends around the circumference of the cladding and along the axial dimension a second preselected distance. The first thickness of the first wall section is thicker than the second thickness of the second wall section. In one embodiment an upper end plug seals a first end of the tubular cladding and a lower end plug seals a second end of the tubular cladding with nuclear fuel occupying at least a portion of the interior of the tubular cladding.

In a preferred embodiment, the second thickness is approximately 0.022 inches (0.05588 cm) and desirably the first thickness is within a range of approximately between 0.045 inches (0.1143 cm) and 0.150 inches (0.3810 cm). Preferably, the first thickness is approximately between 0.045 inches (0.1143 cm) and 0.055 Inches (0.1397 cm).

Desirably, the first and second wall sections are made from discrete tubular members that are welded end-to-end. In still another embodiment, the first and second wall sections are extruded as an integral tubular member. Alternatively, the elongated tubular member is formed from an integral wall section comprising the first wall section and the second wall section. The thickness of the second wall section is then formed by machining an interior of the second wall section. In still another embodiment the lower end portion comprises an extended lower end plug and the first wall section is formed from a hallowed out central cavity in an upper portion of the lower end plug.

Preferably, a transition between the first wall section and the second wall section forms an annular ledge on the interior of the tubular cladding with a larger interior diameter in the second wall section above the transition than exists in the first wall section below the transition. In one of the embodiments, the annular ledge supports the nuclear fuel above the annular ledge for at least a portion of the second preselected distance. Preferably, at least a portion of the first preselected distance forms a gas collection plenum, which distances the active fuel from the lower core plate and reduces the potential for core plate distortion due to gamma heating. Preferably, the first preselected distance is approximately 5.0 inches (12.70 cm).

In still another embodiment, the elongated tubular cladding includes a zirconium oxide coating substantially along an exterior of the lower end portion and preferably the outside diameter of the elongated tubular cladding is substantially the same along substantially the entire axial dimension.

The invention also contemplates an improved nuclear fuel assembly comprising a spaced array of fuel elements at least some of which are constructed as described above and desirably all of the fuel elements are so constructed.

### BRIEF DESCRIPTION OF THE DRAWINGS

A further understanding of the invention can be gained from the following description of the preferred embodiments when read in conjunction with the accompanying drawings in which:

FIG. 1 is a longitudinal view partly in section and partly in elevation of one embodiment of a prior art pressurized water reactor;

FIG. 2 is an elevational view, partially in section, of a fuel assembly in which the preferred embodiment of this invention is incorporated, the assembly being illustrated in vertically shortened form, with parts broken away for clarity;

FIG. 3 is a cross sectional view of a lower portion of one of the fuel elements illustrated in FIG. 2, which shows the cladding configuration of one embodiment of this invention;

FIG. 4 is a cross sectional view of a lower portion of one of the fuel elements illustrated in FIG. 2, which shows the cladding configuration of a second embodiment of this invention; and

FIG. 5 is a cross sectional view of a lower portion of one of the fuel elements illustrated in FIG. 2, which shows the cladding configuration of a third embodiment of this invention.

### DESCRIPTION OF THE PREFERRED EMBODIMENTS

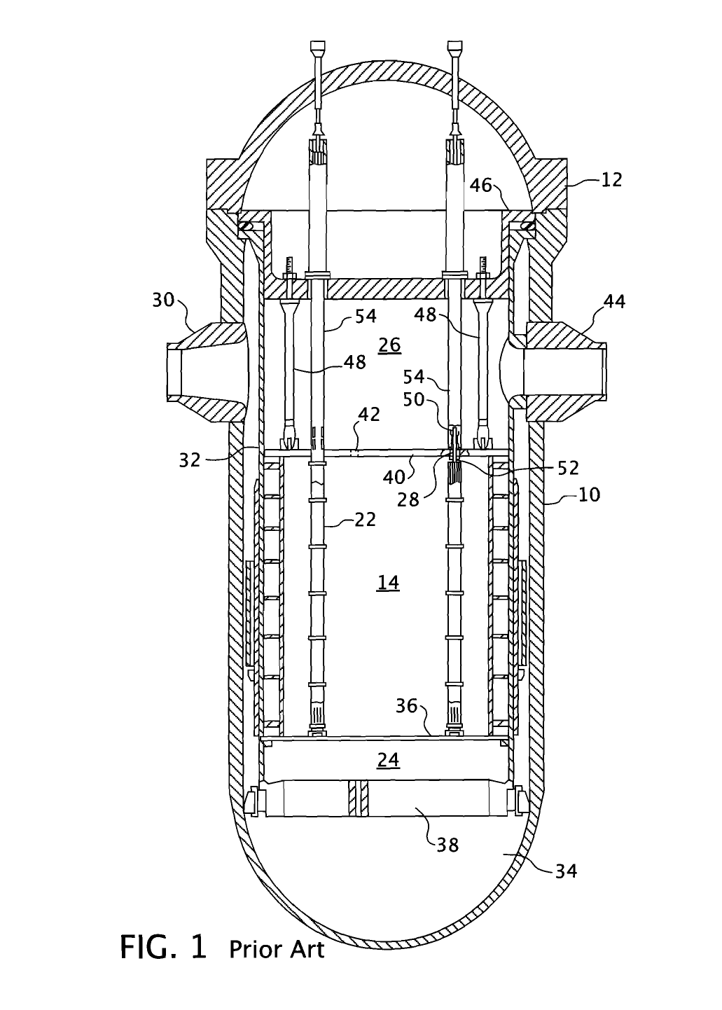

An exemplary reactor design is shown in FIG. 1. In addition to the core 14 comprised of a plurality of parallel, vertical, co-extending fuel assemblies 22, for the purpose of this description, the other vessel internal structures can be divided into the lower internals 24 and the upper internals 26. In conventional designs the lower internals 24 function to support, align and guide core components and instrumentation as well as direct flow within the vessel. The upper internals 26 restrain or provide a secondary restraint for the fuel assemblies 22 (only two of which are shown for simplicity in this figure), and support and guide instrumentation and components, such as control rods 28. In the exemplary reactor shown in FIG. 1, coolant enters the reactor vessel 10 through one or more inlet nozzles 30, flows down through an annulus between the reactor vessel 10 and the core barrel 32, is turned 180° in a lower plenum 34, passes upward through a lower support plate 38 and a lower core plate 36 upon which the fuel assemblies 22 are seated and through and about the assemblies. The fuel assemblies 22 are restrained by upper internals 26, including a circular upper core plate 40. Coolant exiting the core 14 flows along the underside of the upper core plate 40 and upward through a plurality of perforations 42. The coolant then flows upward and radially to one or more outlet nozzles 44.

The upper internals 26 can be supported from the vessel 10 or the vessel head 12 and include an upper support assembly 46. Loads are transmitted between the upper support assembly 46 and the upper core plate 40, primarily by a plurality of support columns 48. A support column is aligned above a selected fuel assembly 22 and perforations 42 in the upper core plate.

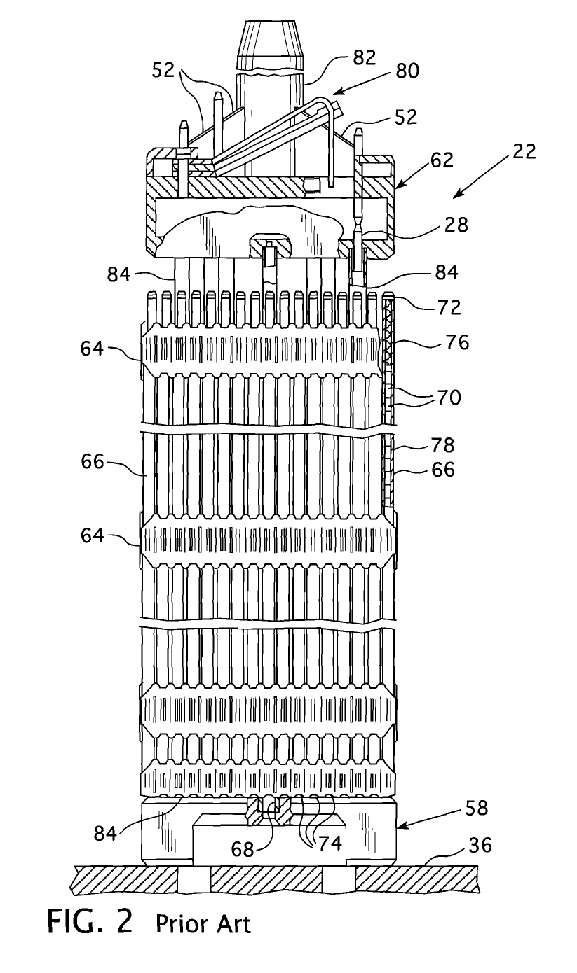

Rectilinearly movable control rods 28 typically include a drive shaft 50 and, as more clearly shown in FIG. 2, a spider assembly having an internally threaded hub member 82 from which a plurality of flukes or arms extend radially and support a plurality of neutron poison control rods 28 that are guided through the upper internals 26 and into aligned fuel assemblies 22 by control rod guide tubes 54. The guide tubes are connected between the upper support assembly 46 and the upper core plate 40.

FIG. 2 is an elevational view, represented in vertically shortened form, of a fuel assembly being generally designated by reference character 22. The fuel assembly 22 is the type used in a pressurized water reactor and has a structural skeleton which, at its lower end, includes a bottom nozzle 58. The bottom nozzle 58 supports the fuel assembly 22 on a lower core support plate 36 in the core region of the nuclear reactor. In addition to the bottom nozzle 58, the structural skeleton of a fuel assembly 22 also includes a top nozzle 62 at its upper end and a number of guide tubes or thimbles 84 and a centrally located instrumentation tube 68, which extend longitudinally between the bottom and top nozzles 58 and 62 and at opposite ends are rigidly attached thereto.

The fuel assembly 22 further includes a plurality of transverse grids 64 axially spaced along and mounted to the guide thimbles 84 and an organized array of elongated fuel rods 66 transversely spaced and supported by the grids 64. Although it cannot be seen in FIG. 2, the grids 64 are conventionally formed from orthogonal straps that are interleaved in an egg-crate pattern with the adjacent interface of four straps defining approximately square support cells through which the fuel rods 66 are supported in transversely spaced relationship with each other. In many conventional designs, springs and dimples are stamped into the opposing walls of the straps that form the support cells. The springs and dimples extend radially into the support cells and capture the fuel rods 66 therebetween; exerting a force on the fuel rod cladding to hold the rods in position. Also, the fuel assembly 22 has an instrumentation tube 68 located in the center thereof that extends between and is either mounted to or passes through the bottom and top nozzles 58 and 62. The former is illustrated in FIG. 2.

Each fuel rod 66 includes a plurality of nuclear fuel pellets 70 and is closed at its opposite ends by upper and lower end plugs 72 and 74. The pellets 70 are maintained in a stack by a plenum spring 76 disposed between the upper end plug 72 and the top of the pellet stack. The fuel pellets 70, composed of fissile material, are responsible for creating the reactive power of the reactor. The cladding 78 which surrounds the pellets 70 functions as a barrier to prevent the fission by-products from the entering the coolant and further contaminating the reactor system.

To control the fission process, a number of control rods 28 are reciprocably movable in the guide thimbles 84 located at predetermined positions in the fuel assembly 22. Specifically, a rod cluster control mechanism 80 positioned above the top nozzle 62 supports the control rods 28. The control mechanism has an internally threaded hub member 82 with a plurality of radially extending flukes, vanes or arms 52. Each vane 52 is interconnected to the control rod 28 such that the control mechanism 80 is operable to move the control rods vertically in the guide thimbles 84 to control the fission process in the fuel assembly 22, under the motor power of control rod drive shafts 50 (shown in FIG. 1), which are coupled to the control rod hubs 82, all in a well-known manner.

In large pressurized water reactors utilized for power generation, the reactor core employs an array of a large number of the fuel rods 66, each containing the fuel pellets 70. Each rod comprises a metal tubular sheath which forms a cladding and may be from 8 to 15 feet (2.4-4.57 meters) long and approximately less than one-half inch (1.27 cm) in diameter, and which contains the stack of cylindrical fuel pellets 70 of suitable fissionable materials such as uranium oxide. Typically, the upper end of the cladding 78 is empty of fuel pellets and forms a plenum for gas or other fission by-products under substantial pressure which fills the top of the rod and also a small clearance space is provided around the fuel pellets 70 to allow for expansion or swelling as a result of irradiation. The fuel rods are supported in parallel groups in the fuel assemblies which may typically contain upwards of 200 fuel rods, and the complete nuclear reactor (such as the one shown in FIG. 1) is made up of a large number of the fuel assemblies containing upwards of 40,000 fuel rods in an active core 14 (although for simplicity, FIG. 1 only shows two such assemblies).

This invention addresses fuel cladding breaches due to debris fretting. As previously mentioned, hard, foreign material that makes its way in the reactor coolant system can migrate through or around the bottom nozzle 58 and become trapped against the fuel rods 66. Fuel cladding wall thickness is normally approximately 0.022 inch (0.056 cm). When the debris is trapped against the cladding 78, it has very little material to wear through before a complete breach occurs. By providing a thicker wall extension to the lower end of the fuel rod cladding, this invention works in cooperation with a number of other features that are available to be incorporated in a fuel assembly to provide additional debris fretting margin.

For example, the invention described in U.S. patent application Ser. No. 10/751,349, relates to a bottom nozzle 58 which, in addition to supporting the fuel assembly 22 on the lower core support plate 36, also contains features which function to filter out most of the potentially damaging size debris from the coolant flow passed upwardly through the bottom nozzle. The bottom nozzle top plate 46 of the debris filter bottom nozzle has a large number of small holes (not shown) that are concentrated in the area of the flow holes through the lower core support plate 36 and are sized to filter out damaging size debris without adversely affecting flow or the pressure drop through the adapter plate and across the fuel assembly 22. The debris filter bottom nozzle serves as both the fuel assembly lower structural element and the first layer of debris defense. In some fuel assemblies, the lower most grid, known as a protective grid or P-grid, also contains filtering features as described in U.S. patent application Ser. No. 12/480,827, filed Jun. 9, 2009 (ARF 2009-002), that forms a second layer of debris defense. Because of the large number of fuel rods and the time and costs of inspecting the fuel rods during a refueling outage, which can adversely affect the critical path during the outage for fuel rod failures and the replacement of failed fuel rods, any further improvement towards achieving a flawless fuel element is highly desirable. The use of a short section of thick cylindrical cladding with or without a zirconium oxide surface coating is employed by this invention as another layer of mitigation to debris fretting.

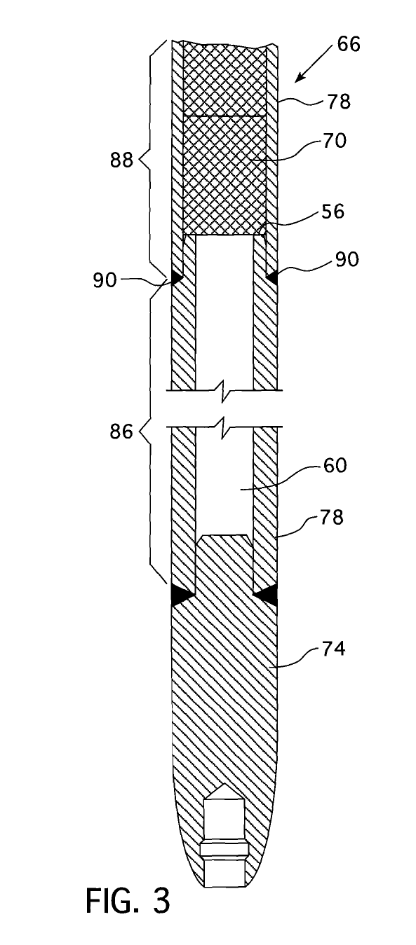

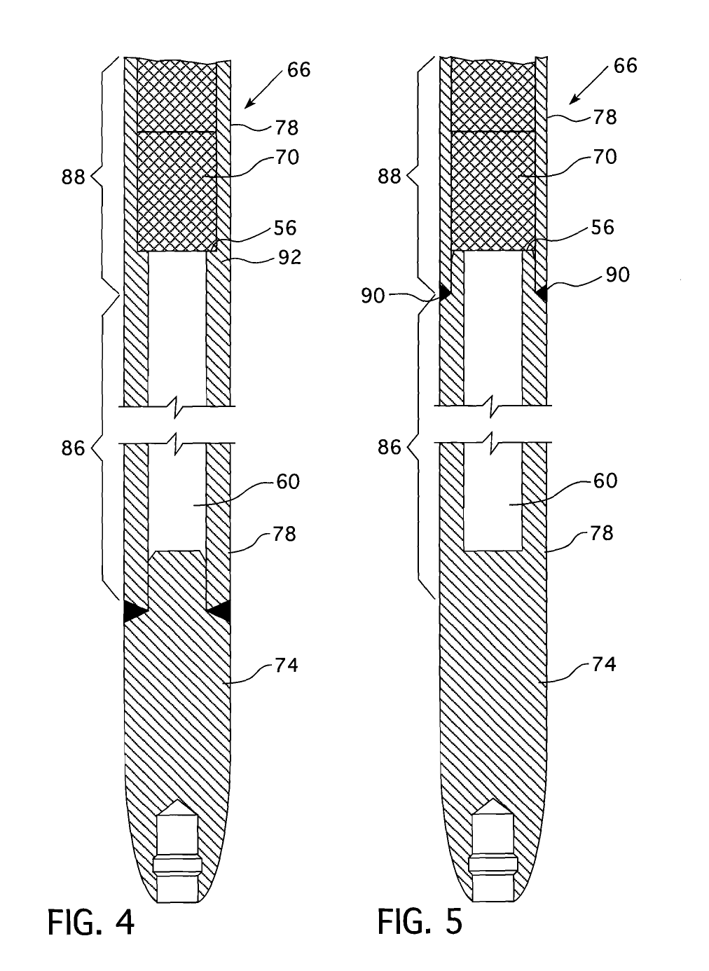

The majority of nuclear fuel rod failures due to debris fretting occur below the bottom support grid or within the bottom 2.5 inches (6.35 cm) of the fuel rod. As shown in FIG. 3, in accordance with one embodiment of this invention a lower section 86 of the cladding 78 is formed from thick walled tubing, constructed preferably out of zirconium, and is welded to a relatively long end plug 74. Preferably, in this embodiment the end plug 74 is a solid end plug. The thick walled tubing section 86 preferably has a thickness between 0.045 inches (0.1143 cm) and 0.150 inches (0.3810 cm), which is more preferably between 0.045 inches (0.1143 cm) and 0.055 Inches (0.1397 cm). The thick walled tubing section 86 extends axially approximately between 2.5 inches (6.35 cm) 5 inches (12.7 cm) and at its upper end forms an annular ledge 56 where it transitions to the upper thin walled tubular cladding section 88. The upper cladding section 88 extends axially above the fuel pellets 70 and terminates at the upper end of the upper plenum that houses the plenum spring 76 (shown in FIG. 2) and is capped by the upper end plug 72. The fuel pellets 70 are supported by the transition annular ledge 56 to form a lower plenum 60 below the fuel pellet stack. The lower plenum 60, obtained by having the thick walled extension, ensures the necessary void volume exists to maintain margin to rod internal pressure limits. The thickness of the upper cladding section 88 is approximately 0.022 inch (0.056 cm). Preferably, the outside diameter of both cladding sections 86 and 88 are the same. The lower section 86 and upper section 88 can be formed from two separate tubular members which are welded together as shown at 90 on the cladding 78 shown in FIG. 3 in the vicinity of the transition or may be formed as one integral tubular member as shown at the transition 92 on the cladding 78 shown in FIG. 4, by either machining the inside diameter of the upper section 88 or by extrusion.

Alternatively, as shown in FIG. 5, in lieu of the thick walled lower tubing section 86, an extended lower end plug 74 can be employed that has a hollowed out upper chamber with a wall thickness comparable to that described above for the lower tubing section 86. The hollowed out upper chamber serves as the lower plenum 60, previously described and the end plug is welded to the upper cladding section 88 at 90 and the top of the end plug forms the annular ledge 56 at the transition of the inside diameter of the cladding 78.

With the configuration of the thick walled tube extension, this invention can maintain the use of the protective grid, oxide coating and the debris filter bottom nozzle to provide multi-layer protection against fuel rod cladding fretting to substantially minimize fuel rod failures. Furthermore, the use of a long solid end plug 74 enables the oxide coating to extend over substantially the entire length of the lower section of the fuel rod for added protection. The zirconium oxide coating adds a three to six micron layer of a material that has superior hardness properties, compared to the cladding material, to further resist fretting.

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention, which is to be given the full breadth of the appended claims and any and all equivalents thereof.

What is claimed is:

1. A nuclear fuel element comprising:
an elongated tubular cladding having an axial dimension and a lower end portion with a first wall section having a first thickness, extending around a circumference of the cladding and a first preselected distance along the axial dimension, the elongated tubular cladding having an upper portion, above the lower end portion, with a second wall section having a second thickness extending around the circumference of the cladding and a second preselected distance along the axial dimension, with the first thickness being thicker than the second thickness; and
nuclear fuel occupying at least a portion of an interior of the tubular cladding.

2. The nuclear fuel element of claim 1 wherein the second thickness is approximately 0.022 in. (0.056 cm).

3. The nuclear fuel element of claim 1 wherein the first thickness is approximately between 0.045 inches (0.1143 cm) and 0.150 inches (0.3810 cm).

4. The nuclear fuel element of claim 3 wherein the first thickness is approximately between 0.045 inches (0.1143 cm) and 0.055 inches (0.1397 cm).

5. The nuclear fuel element of claim 1 wherein the first wall section is welded to the second wall section.

6. The nuclear fuel element of claim 1 wherein the first wall section and second wall section are extruded as an integral wall section.

7. The nuclear fuel element of claim 1 wherein the elongated tubular member is formed from an integral wall section comprising the first wall section and the second wall section and the thickness of the second wall section is formed by machining an interior of the second wall section.

8. The nuclear fuel element of claim 1 wherein a transition between the first wall section and the second wall section forms an annular ledge on the interior of the tubular cladding with a larger interior diameter within the second wall section above the transition than exists in the first wall section below the transition.

9. The nuclear fuel element of claim 8 wherein the annular ledge supports the nuclear fuel above the annular ledge for at least a portion of the second preselected distance.

10. The nuclear fuel element of claim 9 wherein an interior of the lower end portion along at least a part of the first preselected distance forms a gas collection plenum.

11. The nuclear fuel element of claim 1 wherein the first preselected distance is approximately between 2.5 in. (6.35 cm.) and 5.0 inches (12.70 cm).

12. The nuclear fuel element of claim 1 wherein the elongated tubular cladding includes a zirconium oxide coating substantially along an exterior of the lower end portion.

13. The nuclear fuel element of claim 1 wherein an outside diameter of the elongated tubular cladding is substantially the same along substantially the entire axial dimension.

14. The nuclear fuel element of claim 1 including:
an upper end plug sealing a first end of the tubular cladding; and
a lower end plug sealing a second end of the tubular cladding.

15. The nuclear fuel element of claim 1 wherein the lower end portion is formed from a lower end plug that has a hollow chamber extending axially from an upper surface of the lower end plug into the end plug short of an axial length of the end plug and wherein a wall of the hollow chamber forms the first wall section.

16. A nuclear fuel assembly comprising a spaced array of fuel elements wherein at least some of the fuel elements comprise:
an elongated tubular cladding having an axial dimension and a lower end portion with a first wall section having a first thickness, extending around a circumference of the cladding and a first preselected distance along the axial dimension, the elongated tubular cladding having an upper portion, above the lower end portion, with a second wall section having a second thickness extending around the circumference of the cladding and a second preselected distance along the axial dimension, with the first thickness being thicker than the second thickness;
an upper end plug sealing a first end of the tubular cladding;
a lower end plug sealing a second end of the tubular cladding; and
nuclear fuel occupying at least a portion of an interior of the tubular cladding.

17. The nuclear fuel assembly of claim 16 wherein all of the fuel elements comprise:
the elongated tubular cladding having the axial dimension and the lower end portion with the first wall section having the first thickness, extending around the circumference of the cladding and the first preselected distance along the axial dimension, the elongated tubular cladding having the upper portion, above the lower end portion, with the second wall section having the second thickness extending around the circumference of the cladding and the second preselected distance along the axial dimension, with the first thickness being thicker than the second thickness;
the upper end plug sealing the first end of the tubular cladding;
the lower end plug sealing the second end of the tubular cladding; and
the nuclear fuel occupying the at least a portion of the interior of the tubular cladding.
